(19) United States
(12) Patent Application Publication
(10) Pub. No.: US 2020/0374659 A1
(43) Pub. Date: Nov. 26, 2020

(54) Address Allocation Method and Computing Device for Allocating an Address to a Demarcated Location

(71) Applicant: Daimler AG, Stuttgart (DE)

(72) Inventors: Dieter FEDER, Fellbach (DE); Johannes MUELLER, Muenchen (DE)

(73) Assignee: Daimler AG, Stuttgart (DE)

(21) Appl. No.: 16/760,270

(22) PCT Filed: Aug. 28, 2018
(86) PCT No.: PCT/EP2018/073144

§ 371 Date: Apr. 29, 2020

(30) Foreign Application Priority Data
Oct. 30, 2017 (DE) 10 2017 010 181.7

(51) Int. Cl. H04W 4/029; G01C 21/20; G01C 21/32; G01C 21/16

(52) U.S. Cl. CPC H04W 4/029; G01C 21/165; G01C 21/32; G01C 21/206

(57) ABSTRACT

An address allocation method, in which coordinate data is ascertained by a coordinate device, the data characterizing a two-dimensional position of a demarcated location, and in which the ascertained coordinate data is allocated to a sequence of words having at least several words by an allocation device. Elevation data is ascertained by an elevation determination device which characterizes an elevation of the demarcated location relative to a predetermined normal elevation. The sequence of words is adjusted by the allocation device depending on the ascertained elevation data. The sequence of words unambiguously characterizes the coordinate data and the elevation data.

### BACKGROUND AND SUMMARY OF THE INVENTION

The invention relates to an address allocation method and a computing device for allocating an address to a demarcated location.

Such an address allocation method is already known from WO 2014/170646 A1. In the method, a processor receives geographical coordinates of a location and converts these into a plurality of words, which can serve as a location determination. This plurality of words, in particular a three-word sequence, can be remembered particularly easily by users and, with a particularly high probability, can be communicated without error between several users. Moreover, the plurality of words is particularly advantageous in terms of a spoken control system of a navigation device, since the plurality of words can be recorded with a particularly small error margin in comparison to a sequence of numbers. The plurality of words, which clearly describes the geographical coordinates, is also particularly user-friendly to that effect that a sequence of words formed from the plurality of words respectively defines exactly one location, which is not necessarily the case with postal addresses. By means of the this method, a global address system can be created, which divides the world into a grid having squares with a side length of three meters and allocates an unambiguous three-word address to each of these squares. However, this global address system only records a horizontal surface of the world. A three-dimensional address system cannot be compiled by means of the method described, which uses the geographical coordinates.

From DE 198 41 732 A1, a method and a device for inputting into a navigation system are known, in which the geographical location coordinates belonging to a concrete address are converted into a code word by using a data transformer. EP 2 777 304 B1 shows a method for determining a piece of location information of a position in a multi-story building. Further address allocation methods are described in US 2013/0297639 A1 and US 2016/0363453 A1. Furthermore, it is also known from the literature to combine an address allocation method, in which surface coordinates are allocated via a combination of three terms, with elevation information. Here, specifications relating to building structure, such as floors or flat numbers, are used as elevation information.

The object of the present invention is thus to create an address allocation method and a computing device by means of which a three-dimensional address system can be created.

A first aspect of the invention relates to an address allocation method, in which coordinate data is ascertained by means of a coordinate device, the data characterizing a two-dimensional position of a demarcated location. The ascertained coordinate data is allocated to a sequence of words having at least several words, in particular a three-word sequence, by means of an allocation device. The allocation of the coordinate data to the sequence of words or the sequence of words to the coordinate data can take place by means of an allocation regulation stored in an allocation device. The allocation regulation can be, for example, an algorithm and/or a database. The sequence of words comprises at least the several words and can additionally comprise at least one digit. For example, the two-dimensional position of the demarcated location is unambiguously defined with three successive words and, where necessary, at least one additional digit.

In order to develop the address allocation method in such a way that a three-dimensional address system can be created by means of the address allocation method, it is provided according to the invention that elevation data is ascertained by means of an elevation determination device, the data characterizing an elevation of the demarcated location relative to a predetermined normal elevation. The normal elevation can be, for example, Normalhöhennull (height above mean sea level). The elevation data is provided by the elevation determination device for the allocation device, by means of which the sequence of words is compiled or adjusted depending on the ascertained elevation data. For example, the sequence of words can comprise at least one word unambiguously characterizing the elevation data and/or at least one digit characterizing the elevation data. For example, the sequence of words thus comprises the three successive words of the three-word sequence and a digit following the three-word sequence, which together unambiguously characterize the coordinate data, and a further word following the digit, which unambiguously characterizes the elevation data. The demarcated location can thus be three-dimensionally characterized by means of the four words and the one digit. The sequence of words unambiguously characterizes both the coordinate data allocated to the demarcated location and the elevation data allocated to the demarcated location. The described sequence of words can be remembered particularly easily by users because of its brevity and can be correctly recorded particularly easily by a speech recognition device. Thus, when using the address allocation method, a sequence of numbers having a plurality of digits and comprising the coordinate data and the elevation data in its original form is no longer necessary, in which there is a particularly high error margin when using a speech recognition device. Here, the method can be carried out by a computing device, in particular a smart device, which comprises the elevation determination device, the coordinate device and the allocation device. The integration of the coordinate device, the elevation determination device and the allocation device can take place via a software development packet, in particular a software development kit (SDK). Alternatively, a first computing unit can have, for example, a smart device, a sensor device comprising the coordinate device and the elevation determination device and can ascertain the elevation data and the coordinate data. Subsequently, the first computing unit can provide the coordinate data and the elevation data for an external second computing unit, for example a cloud server, which is different to the first computing unit and spaced apart from this. After receiving the coordinate data and the elevation data, the second computing unit, which comprises the allocation device, compiles the sequence of words. The integration between the first computing unit and the second computing unit can take place via an interface for application programming, which is also referred to as an application programming interface (API).

In an advantageous development of the invention, it is provided that the coordinate data is ascertained by means of a global navigation satellite system and/or by means of wireless local area network (WLAN) triangulation and/or by means of a magnetometer for detecting the earth's magnetic field and/or by means of an acceleration sensor device of the coordinate device. In other words, the coordinate data is, for example, geographical coordinates detected by means of the global navigation satellite system. A global navigation satellite system can be, for example, GPS, GLONASS, GALILEO or BeiDou. With sufficient WLAN reception, the coordinate data can be determined by means of the coordinate device via WLAN triangulation. Alternatively or additionally, Bluetooth beacons can be used for the position determination. For the position determination, a triangulation for the Bluetooth beacons takes place analogously to the WLAN triangulation. If the demarcated location is in a magnetically mapped region, then the coordinate data can be ascertained by means of the magnetometer by means of recording the earth's magnetic field. Moreover, an acceleration or a movement of the coordinate device can be ascertained by means of the acceleration sensor device, by means of which the coordinate data can be ascertained. Thus, a particularly safe, simple and exact recording of the coordinate data by means of the coordinate device is possible.

In this context, it has been shown to be advantageous when the coordinate data is ascertained by means of the global navigation satellite system, if the demarcated location is outside a space limited at least upwardly by means of a limiting element and the coordinate data is ascertained by means of the magnetometer for the determination of the earth's magnetic field and/or by means of the acceleration sensor device and/or by means of the WLAN triangulation, if the demarcated location is inside the space limited at least upwardly by means of the limiting element. The space limited at least upwardly by means of the limiting element is to be understood, in particular, as an at least substantially closed space, such as a building, for example. In buildings, a satellite reception of navigation satellite systems is often not sufficient for a precise localization of the coordinate device. In particular, the satellite reception is not sufficient when the coordinate device is in the space limited at least upwardly by means of the limiting element, since the limiting element can form a shield of the space from the reception of the navigation satellite system. If the coordinate device is in the building, then the coordinate data is ascertained by means of the magnetometer and/or by means of the acceleration sensor device and/or by means of the WLAN triangulation. If the coordinate device is outside the building, then the coordinate data is ascertained by means of the global navigation satellite system. Alternatively or additionally, the coordinate data can be ascertained by means of the magnetometer and/or the acceleration sensor device, provided that the satellite reception is not sufficient for ascertaining the coordinate data by means of the global navigation satellite system and/or a WLAN reception is not sufficient for ascertaining the coordinate data by means of the WLAN triangulation of the coordinate device. In particular, the coordinate device is designed to ascertain the coordinate data by means of the global navigation satellite system and/or by means of the WLAN triangulation and/or by means of the magnetometer and/or by means of the acceleration sensor device depending on a respective reception or a respective availability of the respective technology, such that the coordinate device uses the means respectively available to it at the time in order to ascertain the coordinate data as exactly as possible.

In an advantageous embodiment of the invention, it is provided that earth's magnetic field data detected at the demarcated location is compared to earth's magnetic field data stored in a database for determining the coordinate data by means of the magnetometer. In other words, a direct alignment of the ascertained earth's magnetic field data of the demarcated location to a target cartography stored in the database takes place. On one hand, this direct alignment enables a determination of the coordinate data and, on the other hand, a determination of anomalies between the detected earth's magnetic field data and the stored earth's magnetic field data. In additional to the coordinate data, an exactness of the detected coordinate data can thus be evaluated.

Here, it has been shown to be advantageous when the earth's magnetic field data stored in the database is adjusted depending on the comparison and/or a mapping of at least one region comprising the demarcated location is caused, in particular, by means of a detection device, wherein the earth's magnetic field data stored in the database is adjusted depending on the mapping and/or the earth's magnetic field data characterizing the region is stored in the database. This means that, in the event of a detection of anomalies, in particular anomalies of a defined minimum elevation, between the detected earth's magnetic field data and the earth's magnetic field data stored in the database for the demarcated location, the earth's magnetic field data stored in the database is adjusted. For example, the detected earth's magnetic field data is stored in the database as stored earth's magnetic field data for a future earth's magnetic field detection. Alternatively or additionally, the mapping of the region can be caused depending on the comparison, such that the detection device for the mapping detects earth's magnetic field data of the region. This earth's magnetic field data detected by means of the detection device can subsequently be stored in the database. Alternatively, the earth's magnetic field data stored in the database can be adjusted depending on the mapping. Thus, a topicality of the earth's magnetic field data stored in the database can advantageously be ensured. The detection device can be a robot device, for example, by means of which the mapping of the region is carried out. For example, the robot device compiles a magnetic field map of the region. The mapping and the subsequent adjustment of the database can be a semi-automatic update process.

In a further alternative embodiment of the invention, it is provided that the elevation data is ascertained by means of a barometer device of the elevation determination device depending on an air pressure. In other words, the respective air pressure at the demarcated location is determined by means of the elevation determination device, in particular the barometer device, and the elevation data is ascertained depending on the detected air pressure. Here, the elevation determination device can receive weather data and/or air pressure data, in particular via the internet, by means of which the elevation determination device ascertains the elevation data depending on the air pressure ascertained. In particular, the barometer device is regularly calibrated by means of the weather data and/or the air pressure data. In doing so, a falsification of the elevation data ascertained by means of the elevation determination device can advantageously be prevented.

In a further advantageous embodiment of the invention, it is provided that the location is demarcated by dividing a spatial volume into cubes each with a side length of one meter and is unambiguously defined by the sequence of words. This enables a resolution of the spatial volume into a grid with locations each of one cubic meter to be achieved by means of the three-dimensional address system. The spatial volume can be a three-dimensional region of the earth including the atmosphere. A navigation in the three-dimensional spatial volume to the location characterized by the defined sequence of words is thus possible particularly precisely. For example, a drone or a vehicle can be navigated particularly precisely to the location characterized by the defined sequence of words by an extension of about one cubic meter. Furthermore, a person, for example, can be navigated particularly easily and precisely to the location characterized by the defined sequence of words.

It has been proved to be particularly advantageous when the coordinate data can be unambiguously allocated to three successive words, in particular the three-word sequence and a digit of the sequence of words, and the elevation data can be unambiguously allocated to a further word of the sequence of words. The coordinate data is thus unambiguously characterized by the three successive words and the subsequent digit, while the elevation data is unambiguously characterized by the further word. In doing so, the sequence of words can be designed to be particularly short, wherein a particularly precise three-dimensional localization of the location is nevertheless possible.

A second aspect of the invention relates to a computing device for allocating an address to a demarcated location, having a coordinate device, by means of which coordinate data characterizing a two-dimensional position of the demarcated location can be ascertained. Furthermore, the computing device comprises an elevation determination device, by means of which an elevation of the demarcated location relative to a predetermined normal elevation can be ascertained. In addition, the computing device has an allocation device, by means of which the coordinate data can be allocated to a sequence of words having at least several words, in particular a three-word sequence, and by means of which the sequence of words can be compiled or adjusted depending on the elevation data ascertained, wherein the sequence of words unambiguously characterizes the coordinate data allocated to the demarcated location and the elevation data. In other words, the computing device comprises the coordinate device, the elevation determination device and the allocation device. In doing so, the computing device is able to unambiguously allocate the sequence of words to any demarcated location at which it is located. A further computing device can ascertain the coordinate data allocated to the demarcated location and the elevation data allocated to the demarcated location by means of the sequence of words without having to be present at the demarcated location itself, provided that it receives the sequence of words from the computing device mentioned first. The computing devices can be, for example, smart devices, such as smart phones, tablets, computers, smart watches or laptops.

Advantages and advantageous embodiments of the address allocation method according to the invention can be seen as advantages and advantageous embodiments of the computing device according to the invention. For this reason, the advantages and advantageous embodiments of the computing device according to the invention are not described again here.

Further advantages, features and details of the invention result from the following description of a preferred exemplary embodiment as well as with the aid of the drawings. The features and combinations of features specified in the description above and the features and combinations of features specified in the description of the Figures and/or in the Figures only below can be used not only in the combination specified in each case, but also in other combinations or on their own without exceeding the scope of the invention.

### BRIEF DESCRIPTION OF THE DRAWINGS

FIG. 1 is a schematic perspective view of nine demarcated locations that can be allocated to a three-word sequence, wherein the depicted demarcated locations can respectively be distinguished from one another by means of a digit allocated to them according to a fixed formula; and

FIG. 2 is a schematic view of a building, which is divided into a plurality of locations that can be unambiguously characterized by means of a sequence of words, wherein the sequence of words represents both coordinate data characterizing a two-dimensional position of the location and elevation data characterizing an elevation of the demarcated location relative to a predetermined normal elevation.

### DETAILED DESCRIPTION OF THE DRAWINGS

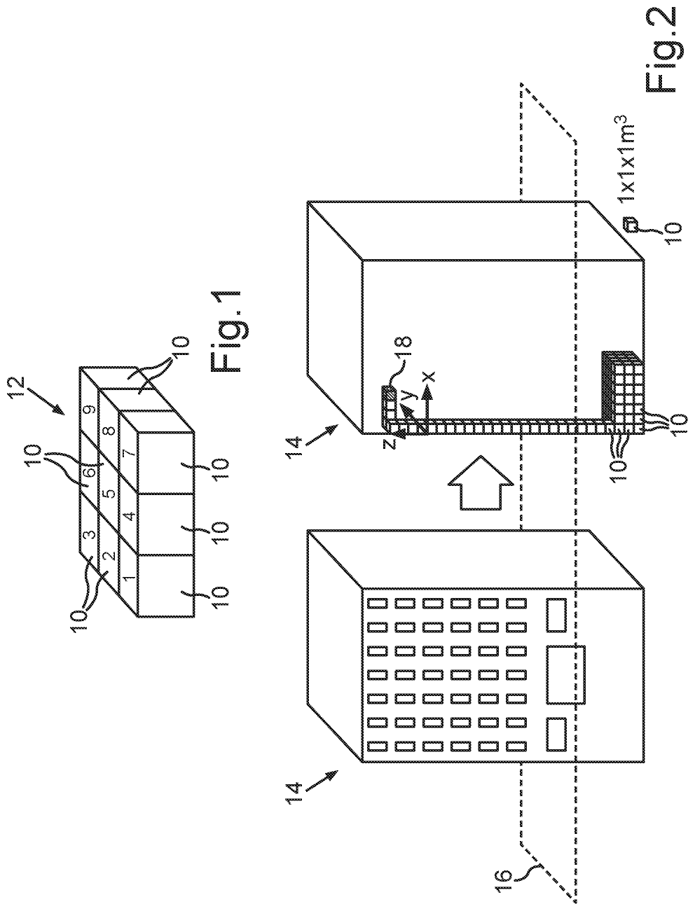

In FIG. 1, in a schematic perspective view, a plurality of locations 10 that can be allocated to an identical three-word sequence comprising three words is depicted. These locations 10 are each provided with a digit of from 1 to 9, which describes its position within a three-word sequence square 12 characterized by the three-word sequence. For example, the three-word sequence can be a three-word sequence square 12 of the so-called “What3Words” concept. Presently, this three-word sequence square 12 is divided into nine smaller squares, each with a square meter. The “What3Words” concept uses three words for the position determination and thus achieves an exactness of nine square meters. As a result of the division into nine smaller squares, an exactness can be increased to one square meter.

In FIG. 2, a building 14 is depicted in a schematic perspective view. The building 14 is divided into a plurality of demarcated locations 10 with a respective dimension of one meter tall, one meter wide and one meter deep. Each of these locations 10 is characterized by an unambiguous sequence of words. Presently, the sequence of words comprises the three-word sequence of the respective three-word sequence square 12, the respective digit for specifying the position inside the three-word sequence square 12 and an identifier for an elevation specification of the respective location 10.

Presently, the identifier for the elevation specification comprises a further word, wherein the further word characterizes elevation data, which characterizes an elevation of the respective demarcated location 10 relative to a predetermined normal elevation 16. Presently, the normal elevation 16 is the zero elevation or sea level. The elevation data can be ascertained by means of an elevation determination device and transferred to an allocation device. Coordinate data, which characterizes a two-dimensional position of the respective demarcated location 10, can be ascertained by means of a coordinate device and transferred to the allocation device. The allocation device presently ascertains the three-word sequence of the “What3Words” concept and the digit for the position inside the three-word sequence square 12 from the coordinate data. Moreover, the sequence of words presently comprises the further word unambiguously characterizing the elevation data. If it is assumed that locations 10 are to be characterized which are to be identified up to 12000 meters into the ground and thus below the normal elevation 16, for this, one word per depth meter and thus, in total, 12,000 words are defined. With an elevation to be identified of up to 16,000 meters above the normal elevation 16, a further 16,000 words can be used.

In the depicted schematic view in FIG. 2, the defined location 18 is on an elevation level of 21 meters above the normal elevation 16, wherein the elevation level is presently described by the word “ermöglicht”. If the defined location 18 is additionally arranged in the three-word sequence “erfreut.bewahrte.kurzfilm.” and assumes the position 2 in this three-word sequence square, then the position of the defined location 18 can be described by the word sequence “erfreut.bewahrte.kurzfilm.2ermöglicht”.

A respective position of a respective location 10 can be allocated to a respective sequence of words using a computing device formed as a smart phone. For this, the computing device comprises the coordinate device, by means of which coordinate data characterizing the two-dimensional position of the demarcated location 10 can be ascertained. Furthermore, the computing device comprises the elevation determination device, by means of which elevation data characterizing the elevation of the demarcated location 10 relative to the predetermined normal elevation 16 can be ascertained. Moreover, the computing device can comprise the allocation device, by means of which the coordinate data can be allocated to the three-word sequence and the digit and the elevation data to the further word. Moreover, the allocation device compiles the sequence of words depending on the coordinate data and the elevation data. The sequence of words unambiguously characterizes the coordinate data and elevation data allocated to the demarcated location 10.

The coordinate device can ascertain the coordinate data by means of a global navigation satellite system and/or by means of WLAN triangulation and/or by means of a magnetometer for the earth's magnetic field detection and/or by means of an acceleration sensor device. Here, it has been shown to be particularly advantageous when the coordinate device ascertains the coordinate data inside the building 14 at least by means of the magnetometer for the earth's magnetic field detection and by means of the acceleration sensor device, since a data reception of the global navigation satellite system and, where necessary, a WLAN reception for carrying out the WLAN triangulation can be too weak inside the building 14 for the detection of the coordinate data. For the determination of the coordinate data by means of the magnetometer, the building 14 can become or be mapped in its inside in relation to the earth's magnetic field. This mapping can take place by means of a robot. A position determination of the coordinate data by means of the earth's magnetic field leads to a particularly high precision of a three-dimensional address system that can be created by means of an address allocation method with an accuracy of one cubic meter and enables its use in buildings and urban areas inter alia.

Earth's magnetic field data is ascertained by means of the magnetometer for the position determination and is compared to earth's magnetic field data representing the mapping and stored in a database. Since the mapping of the earth's magnetic field is dependent on a construction of the building 14, in particular since metal in buildings can change earth's detectable magnetic field, a dynamic adjustment of earth's magnetic field data stored in the database is significant in the event of constructive changes to the building 14 and/or adjacent buildings or infrastructure. This dynamic adjustment can take place by means of an adjustment of earth's magnetic field data stored in the database depending on the detected magnetic field data of earth. In particular, the detected magnetic field data of earth is stored in the database. Alternatively or additionally, a renewed mapping can be caused depending on the comparison between the detected magnetic field data of earth and magnetic field data of earth stored in the database in the event of exceeding a threshold value for anomalies ascertained in the comparison. This renewed mapping of the building 14 can be carried out by means of the robot.

Presently, the computing device can ascertain the elevation data by means of the elevation determination device designed as a barometer device depending on an air pressure. The computing device can align this air pressure to weather data in order to lead to the conclusion from the detected air pressure at a respective location 10 of the respective elevation data that can be allocated to the respective location 10. Presently, the computing device can receive the weather data via the internet and compare the weather data to the detected air pressure in order to ascertain the elevation data.

With the address allocation method, the coordinate data is determined for the defined location 18 by means of the coordinate device and allocated to the sequence of words, which comprises at least several words and presently comprises a digit, by means of the allocation device. Furthermore, with the address allocation method, the elevation data is ascertained by means of the elevation determination device and the sequence of words is compiled or adjusted by means of the allocation device depending on the elevation data ascertained.

Here, the idea underlying the address allocation method described is that logistical applications aim for a control and optimization of different goods and flows of people. A main problem of private and commercial logistics is here a location-accurate localization and tracking of people or goods in the three-dimensional space. The address allocation method described enables a three-dimensional localization with an accuracy of a height of one meter by a width of one meter by a depth of one meter both in buildings and in open areas. By extending the “What3Words” concept by the vertical third dimension—above or below sea level by means of air pressure—the three-dimensional address system can be created by means of the address allocation method described. The three-dimensional address system can also be referred to as four-word mapping.

Thus, the global three-dimensional address system can be compiled by means of the address allocation method described, which divides the earth and its atmosphere into cubes of one cubic meter and provides it with a specific nomenclature, presently the sequence of words. The address allocation method enables a global position determination, which is much more precise than conventional addresses. Positions in underground car parks, warehouses or in tower blocks can also be included by the third dimension. Moreover, the computing device contains currently obtainable and particularly favorable available technologies, which can be combined and can be set up to presently carry out the address allocation method on a smart phone.

The position determination by means of the sequence of words, which can also be referred to as four-word sequence, is particularly easy to use and, in any application, private and commercial, enables an unambiguous three-dimensional localization. Moreover, a particularly high granularity of the address system can be created by means of the address allocation method, and a vertical and horizontal localization of the respective locations 10 is carried out three-dimensionally. A drone delivery of a parcel to the defined location 18 or a person collection service come into question as exemplary applications. Moreover, the three-dimensional address system can serve to locate a car boot in a car park and to deliver goods into the car boot. Moreover, the three-dimensional address system enables a particularly advantageous and precise navigation of vehicles, such that an autonomously driving HGV can autonomously travel a final mile. In a production process, with fully automated applications, a robot can be informed about a crate by means of the three-dimensional address system, which is intended to receive and transport this. Thus, the three-dimensional address system can be used for delivery and navigation scopes for people and logistics in building, on different floors, in underground car parks, underground, in mines, in depots, in high rack warehouses, in mountains etcetera.

So that the described address system functions both in the open and in urban centers, buildings and, for example, underground car parks, the address allocation method uses a vertical localization, which is carried out by means of the elevation determination device and a horizontal localization, which is carried out by means of the coordinate device. If the address allocation method is carried out by means of the computing device formed as a smart phone, then the smart phone can use GPS and WLAN data and sites of mobile radio towers for the horizontal localization. In buildings or urban centers, in which the conventional site determination by means of GPS, WLAN data and sites of mobile signal towers does not function sufficiently, the smart phone uses the magnetometer for measuring the magnetic field of the earth in the address allocation method. The magnetic field of the earth is specific to each point, similar to a fingerprint. Thus, the horizontal localization can be undertaken by the smart phone without additional hardware. In an optional combination with an acceleration sensor of the acceleration sensor device, which is an accelerometer on three axes, a precise position and movement recognition emerges.

A conventional elevation measuring for a vertical localization usually functions via satellite triangulation, in particular GPS. This conventional elevation measuring indeed functions without internet connection, yet is often very slow and inaccurate. Therefore, with the described address allocation method, the air pressure is used to ascertain the elevation data. Since, along with the elevation, current weather conditions also have an impact on the air pressure, the barometer device of the elevation determination device is presently regularly calibrated via the nearest weather stations. This calibration can take place via a communication via the internet. In terms of the determination of elevation data, the acceleration sensor device can moreover be used in order to specify a position and movement course of the computing device.

1.-8. (canceled)

9. A method for address allocation, comprising the steps of:
ascertaining coordinate data by a coordinate device, wherein the coordinate data characterizes a two-dimensional position of a demarcated location;
allocating the ascertained coordinate data to a sequence of words having a plurality of words by an allocation device; and
ascertaining elevation data by an elevation determination device, wherein the elevation data characterizes an elevation of the demarcated location relative to a predetermined normal elevation; and
adjusting the sequence of words depending on the ascertained elevation data by the allocation device;
wherein the sequence of words unambiguously characterizes the coordinate data and the elevation data;
wherein the coordinate data is ascertained by a magnetometer for detecting a magnetic field of earth.

10. The method according to claim 9, wherein:
the coordinate data is ascertained by a global navigation satellite system if the demarcated location is outside a space limited at least upwardly by a limiting element;
the coordinate data is ascertained by the magnetometer and/or by an acceleration sensor device and/or by wireless local area network (WLAN) triangulation if the demarcated location is inside the space limited at least upwardly by the limiting element.

11. The method according to claim 9 further comprising comparing the coordinate data to magnetic field of earth data stored in a database.

12. The method according to claim 11, wherein depending on the comparing, adjusting the magnetic field of earth data stored in the database and/or mapping of a region comprising the demarcated location, wherein, depending on the mapping, the magnetic field of earth data stored in the database is adjusted.

13. The method according to claim 9, wherein the elevation data is ascertained by a barometer device of the elevation determination device depending on an air pressure.

14. The method according to claim 9, wherein the demarcated location is determined by dividing a spatial volume into cubes with 1 meter side lengths and is unambiguously defined by the sequence of words.

15. The method according to claim 9, wherein the coordinate data is unambiguously allocated to three successive words of the sequence of words and a digit of the sequence of words and wherein the elevation data is unambiguously allocated to a further word of the sequence of words.

16. A computing device for allocating an address to a demarcated location, comprising:
a coordinate device, wherein coordinate data characterizing a two-dimensional position of the demarcated location is ascertainable by the coordinate device;
an elevation determination device, wherein elevation data characterizing an elevation of the demarcated location relative to a predetermined normal elevation is ascertainable by the elevation determination device; and
an allocation device, wherein the coordinate data is allocatable to a sequence of words having a plurality of words by the allocation device and wherein the sequence of words is adjustable by the allocation device depending on ascertained elevation data;
wherein the sequence of words unambiguously characterizes the coordinate data and the elevation data.
